(19) United States
(12) Patent Application Publication
(10) Pub. No.: US 2010/0143031 A1
(43) Pub. Date: Jun. 10, 2010

(54) MECHANICAL FASTENER HAVING A THREAD STAKING MECHANISM

(75) Inventors: Brad Chamberlin, Pendleton, IN (US); Alex Creviston, Muncie, IN (US)

Correspondence Address: CANTOR COLBURN, LLP, 20 Church Street, 22nd Floor, Hartford, CT, 06103, US

(73) Assignee: REMY TECHNOLOGIES, L.L.C., Pendleton, IN (US)

(21) Appl. No.: 12/396,664

(22) Filed: Mar. 3, 2009

(51) Int. Cl. F16B 12/10; F16B 39/04

(52) U.S. Cl. 403/409.1; 411/221

(57) ABSTRACT

A mechanical fastener includes a main body having an outer diametric portion and an inner diametric portion and a plurality of threads provided on at least one of the outer and inner diametric portions. The mechanical fastener further includes at least one staking mechanism formed in the main body at the at least one of the outer and inner diametric portion. The at least one staking mechanism extends into and bisects at least a portion of the plurality of threads.

### BACKGROUND

Exemplary embodiments of the invention relate to the art of mechanical fasteners and, more particularly, to a mechanical fastener having a soft stake thread locking mechanism.

Often times it is desirable to ensure that, once secured, a mechanical fastener is prevented from becoming loose. There exist several methods of preventing loosening of a mechanical fastener. As one example, applying a specified torque to a fastener will ensure a particular fit and prevent loosening. Welding the fastener to adjacent structure will also prevent subsequent movement. Other methods of limiting fastener movement include the use of locking or spring washers and staking or peening. Locking or spring washers exert a force on the fastener that creates an interference between mating threads, peening or staking creates a localized deformation that creates an interlock between the fastener and adjacent structure, e.g., between a nut and a bolt.

It is often undesirable to employ torque to prevent a fastener from becoming loose. The amount of torque required to retain the fastener may limit movement between adjacent parts or impart too much force on a part. Welding requires heat that can damage adjacent structure. The use of a locking or spring washer, while effective in many applications, is not as effective in applications that experience vibration. Over time, the vibration may cause the fastener to become loose. Both staking and peening require that a force be applied to the fastener, often times in an axial direction. The amount of force required to stake and/or peen a mechanical fastener could also damage associated components. More specifically, staking a fastener associated with a bearing or a sensor could result in damage. Deforming a bearing race could reduce operability while sharp impacts to a senor could affect sensor output.

### SUMMARY

In accordance with an exemplary embodiment a mechanical fastener includes a main body having an outer diametric portion and an inner diametric portion and a plurality of threads provided on at least one of the outer and inner diametric portions. The mechanical fastener further includes at least one staking mechanism formed in the main body at the at least one of the outer and inner diametric portion. The at least one staking mechanism extends into and bisects at least a portion of the plurality of threads.

In accordance with another exemplary embodiment, a method of staking a mechanical fastener to a component includes threadingly engaging a mechanical fastener having a main body including an outer diametric portion, and inner diametric portion and a plurality of threads provided on at least one of the outer diametric portion and the inner diametric portion to a component having a plurality of threads. The method further includes inserting a staking member into a staking feature formed in the main body of the mechanical fastener. The staking feature projects into and bisects at least a portion of the plurality of threads on the one of the outer diametric portion and the inner diametric portion. A controlled force is applied to the plurality of threads on the component through the staking member. The controlled force is adapted to deform at least one of the plurality of threads.

Additional features and advantages are realized through the techniques of exemplary embodiments of the present invention. Other embodiments and aspects of the invention are described in detail herein and are considered a part of the claimed invention. For a better understanding of the invention with advantages and features, refer to the description and to the drawings.

### BRIEF DESCRIPTION OF THE SEVERAL VIEWS OF THE DRAWINGS

The subject matter which, is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is an upper perspective view of a mechanical fastener constructed in accordance with an exemplary embodiment;

FIG. 2 is a partial, cross-sectional view of the mechanical fastener mounted to a component; and

FIG. 3 is an upper perspective view of a mechanical fastener constructed in accordance with another exemplary embodiment.

### DETAILED DESCRIPTION

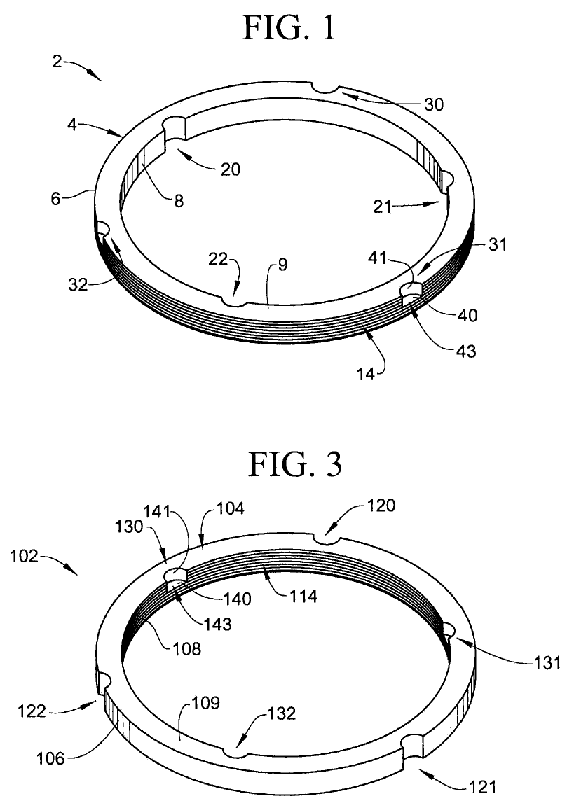

With initial reference to FIG. 1, a mechanical fastener constructed in accordance with exemplary embodiments is generally indicated at 2. Mechanical fastener 2 includes a main body 4 having an outer diametric portion 6 and an inner diametric portion 8 as well as a first substantially planar surface 9 and a second, opposing substantially planar surface (not shown). Mechanical fastener 2 is further shown to include a plurality of threads 14 arranged on outer diametric portion 6 as well as a plurality of spanner receivers 20-22 arranged on inner diametric portion 8. Spanner receivers 20-22 are configured to receive, for example, a spanner wrench employed in connection with tightening and loosening mechanical fastener 2.

In further accordance with the exemplary embodiments, mechanical fastener 2 includes a staking mechanism that takes the form of a plurality of staking features 30-32 arranged on outer diametric portion 6. As further shown in FIG. 1, each of the plurality of staking features is evenly spaced about outer diametric portion 6 and extends into main body 4. At this point, it should be understood that as each of the plurality of staking features 30-32 is similarly formed, a detailed description will follow with respect to staking feature 31 with an understanding that remaining staking features 30 and 32 are similarly formed. In the exemplary embodiment, staking feature 31 includes a bottom wall section 40 and an arcuate wall section 41 that define a void that bisects the plurality of threads 14. At this point it should be understood that by “bisects”, it is meant that each staking feature 30-32 creates an interruption in the plurality of threads 14 formed on main body 4. As will be discussed more fully below, staking features 30-32 provide structure for staking mechanical fastener 2 in place without applying any force to mechanical fastener 2.

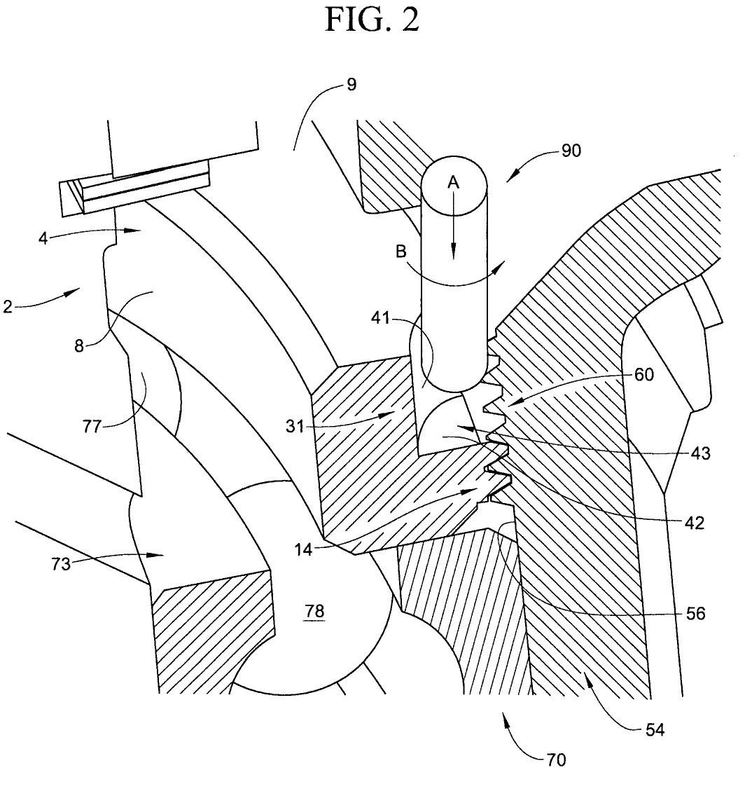

As best shown in FIG. 2, mechanical fastener 2 is affixed to a component 54 having an opening 56 provided with a plurality of threads 60. That is, mechanical fastener 2 is threadingly engaged with threads 60 in order to retain, for example, a bearing member 70 to component 54. In the exemplary embodiment shown, bearing member 70 includes a bearing race 73 as well as a plurality of bearings, two of which are indicated at 77 and 78. With this arrangement, mechanical fastener 2 is tightened against bearing race 73 and secured with an appropriate amount of torque. Once secured, a staking member 90 is inserted into each staking feature 30-32. At this point, a controlled force is applied to staking member 90 so as to stake or deform a portion of the plurality of threads 60 on component 54. With this particular arrangement, either a controlled axial force as indicated by arrow A or a controlled rotational force as indicated by arrow B is imparted to staking member 90 to deform threads 60. By providing staking features 30-31, threads 60 are deformed in a “soft stake”, e.g., without imparting any force whatsoever to mechanical fastener 2. In this manner, mechanical fastener 2 is ensured of retaining its position relative to bearing member 70 without having forces transmitted to bearing race 73. Forces passing though mechanical fastener 2 toward bearing member 70 may deform and/or otherwise damage bearing race 73 and shorten an overall operational lifespan of component 54.

FIG. 3 illustrates a mechanical fastener 102 constructed in accordance with another exemplary embodiment. In a manner similar to that describe above, mechanical fastener 102 includes a main body 104 having an outer diametric portion 106 and an inner diametric portion 108 as well as a first substantially planar surface 119 and a second, opposing substantially planar surface (not shown). Mechanical fastener 102 is further shown to include a plurality of threads 114 arranged on inner diametric portion 108 as well as a plurality of spanner receivers 120-122 arranged on outer diametric portion 106. Spanner receivers 120-122 are configured to receive, for example, a spanner wrench employed in connection with tightening and loosening mechanical fastener 102.

In further accordance with the exemplary embodiments, mechanical fastener 102 includes stacking mechanism that takes the form of a plurality of staking features 130-132 arranged on inner diametric portion 108. As further shown in FIG. 3, each of the plurality of staking features 130-132 is evenly spaced about inner diametric portion 108 and extends into main body 14. At this point, it should be understood that as each of the plurality of staking features 130-132 is substantially identically constructed, a detailed description will follow with respect to staking feature 131 with an understanding that remaining staking features 130 and 132 are similarly formed. In the exemplary embodiment, staking feature 131 includes a bottom wall section 140 and an arcuate wall section 141 that define a void that bisects the plurality of threads 114. It should be understood that by “bisects”, it is meant that each staking feature 130-132 creates an interruption in the plurality of threads 114 formed on main body 104. In a manner similar to that discussed above, staking features 130-132 provide structure for staking mechanical fastener 102 in place without applying any force to main body 104.

At this point it should be understood that the exemplary embodiments described above are but examples. The staking mechanism in accordance with the exemplary embodiment can take on a variety of forms and should not be limited to the geometric shapes illustrated in the figures so long as access is provided to structure on a mating component to allow the application of a controlled force only to the mating component. Towards that end, while described as being employed to stake threads, other structure employed for joining form mechanical components can also be employed without departing from the spirit of the exemplary embodiment as claimed.

In general, this written description uses examples to disclose exemplary embodiments, including the best mode, and also to enable any person skilled in the art to practice the exemplary embodiment, including making and using any devices or systems and performing any incorporated methods. The patentable scope of the exemplary embodiment is defined by the claims, and may include other examples that occur to those skilled in the art. Such other examples are intended to be within the scope of exemplary embodiments if they have structural elements that do not differ from the literal language of the claims, or if they include equivalent structural elements with insubstantial differences from the literal language of the claims.

1. A mechanical fastener comprising:
a main body having an outer diametric portion and an inner diametric portion;
a plurality of threads provided on at least one of the outer and inner diametric portions; and
at least one staking mechanism formed in the main body at the at least one of the outer and inner diametric portion, the at least one staking mechanism extending into and bisecting at least a portion of the plurality of threads.

2. The mechanical fastener according to claim 1, wherein the plurality of threads are provided in the outer diametric portion.

3. The mechanical fastener according to claim 1, wherein the plurality of threads are provided on the inner diametric portion.

4. The mechanical fastener according to claim 1, wherein the at least one staking mechanism includes a first staking feature, a second staking feature and a third staking feature, each of the first, second and third staking features being spaced about the one of the outer and inner diametric portions.

5. The mechanical fastener according to claim 4, wherein each of the first, second and third staking features are evenly spaced about the one of the outer and inner diametric portions.

6. The mechanical fastener according to claim 1, wherein the staking mechanism is a void formed in the main body.

7. The mechanical fastener according to claim 6, wherein the void includes at least one wall section.

8. The mechanical fastener according to claim 7, wherein the at least one wall section is arcuate.

9. A method of staking a mechanical fastener to a component, the method comprising:
threadingly engaging a mechanical fastener having a main body including an outer diametric portion, and inner diametric portion and a plurality of threads provided on at least one of the outer diametric portion and the inner diametric portion to a component having a plurality of threads;
inserting a staking member into a staking feature formed in the main body of the mechanical fastener, the staking feature projecting into and bisecting at least a portion of the plurality of threads on the one of the outer diametric portion and the inner diametric portion; and
applying a controlled force to the plurality of threads on the component through the staking member, the controlled force being adapted to deform at least one of the plurality of threads.

10. The method of claim 9, wherein applying the controlled force to the plurality of threads comprises applying an axial force to the staking member, the axial force passing along a longitudinal axis of the staking member.

11. The method of claim 9, wherein applying the controlled force to the plurality of threads comprises applying a rotational force to the staking member, the rotational force passing around a longitudinal axis of the staking member.

12. The method of claim 9, wherein applying the controlled force comprises applying a gradual force to the staking member.

13. The method of claim 12, wherein applying the gradual force comprises applying a non-impact force to the staking member.
